(19) United States
(12) Patent Application Publication
(10) Pub. No.: US 2014/0045677 A1
(43) Pub. Date: Feb. 13, 2014

(54) INORGANIC HYDROPHILIC SELF-CLEANING COATINGS

(71) Applicants: William Brenden Carlson, Seattle, WA (US); Angele Sjong, Louisville, CO (US); Feng Wan, Issaquah, WA (US); Timothy Londergan, Seattle, WA (US)

(72) Inventors: William Brenden Carlson, Seattle, WA (US); Angele Sjong, Louisville, CO (US); Feng Wan, Issaquah, WA (US); Timothy Londergan, Seattle, WA (US)

(73) Assignee: EMPIRE TECHNOLOGY DEVELOPMENT LLC, Wilmington, DE (US)

(21) Appl. No.: 13/816,960

(22) PCT Filed: Aug. 10, 2012
(86) PCT No.: PCT/US12/50293

§ 371 Date: Feb. 14, 2013

(51) Int. Cl. C09D 1/00

(52) U.S. Cl. CPC C09D 1/00
USPC 502/1

(57) ABSTRACT

Hydrophilic coating compositions and methods to make and use the compositions are disclosed. The compositions may include at least one metal organic oxide and at least one inorganic photocatalytic pigment. The metal organic oxide may contact the inorganic photocatalytic pigment non-covalently. A coating composition may be applied to a substrate to coat the substrate.

### BACKGROUND

Decorative coatings and paints are used by consumers and industrial users to beautify and protect substrates. The most simple coatings and paints are made of a polymer (the binder) in a solvent (the vehicle), which is commonly called a lacquer. Paints and coatings are used to modify the appearance of an object by adding color, gloss, or texture and by blending with or differentiating from a surrounding environment. For example, a surface that is highly light scattering (i.e. a flat surface) can be made glossy by the application of a paint that has a high gloss. Conversely, a glossy surface can be made to appear flat. Thus, the painted surface is hidden, altered, and ultimately changed in some manner by the presence of the coating. In addition, decorative paints protect the surface from the surrounding elements and prevent corrosion.

Due to environmental regulations, it is desirable to limit the amount of organic solvents in the paint as they may harm the environment upon release. Organic solvents such as methyl ethyl ketone, toluene, methylene chloride and the like have traditionally been used as paint vehicles. Due to the regulations, there are limitations as to how much organic solvent can be present in a coating. It is desired that new paint and coating formulations are water-based or release very few solvents into the environment.

Although paints and coatings alter the appearance of the surface, the coating itself can get dirty over time. Dirt can dull the coating by scattering light or modifying the color. Many attempts to create organic coatings that resist dirt and contamination have been undertaken. In one case, hydrophobic coatings with a low surface energy that resist water and, thus, are resistant to dirt have been created. For example, highly fluorinated polymers related to Teflon have been used for this purpose. These coatings often have a surface energy of not more than 15 dynes, which results in water forming beads on the surface rather than wetting the surface. Generally, these coatings become contaminated more slowly and maintain the appearance of the object longer, but they still eventually need to be cleaned. Thus, it would be desirable to have a coating with minimal or no organic solvents and with a hydrophilic surface that cleans itself.

### SUMMARY

The present disclosure provides paints and coatings that provide a hydrophilic, self-cleaning surface when coated on an object. In an embodiment, a hydrophilic, self-cleaning coating composition comprises at least one metal organic oxide and at least one inorganic photocatalytic pigment, wherein the metal organic oxide contacts the inorganic photocatalytic pigment non-covalently.

In an embodiment, a method of providing a hydrophilic, self-cleaning surface to a substrate may involve applying a paint composition to the substrate, wherein the paint composition comprises at least one metal organic oxide and at least one inorganic photocatalytic pigment, wherein the metal organic oxide contacts the inorganic photocatalytic pigment non-covalently.

In an embodiment, a coated substrate may be a substrate with a hydrophilic and self-cleaning coating on the surface, wherein the composition of the coating comprises at least one metal organic oxide and at least one inorganic photocatalytic pigment, wherein the metal organic oxide contacts the inorganic photocatalytic pigment non-covalently.

### BRIEF DESCRIPTION OF THE FIGURES

FIG. 1 depicts a curing mechanism of a hydrophilic paint according to an embodiment.

FIG. 2 shows the photocatalytic activity of titanium dioxide and production of free radicals according to an embodiment.

FIG. 3 depicts a coating with a metal organic oxide and titanium dioxide particles according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

Decorative coatings and paints are high volume consumer products. As the name implies, a function of a decorative coating is to make an object look more visually appealing. However, in addition to accomplishing the beautification of an object, the coating can also afford some degree of substrate protection. As paints and coatings become covered and contaminated with unwanted substances, the appearance of the object often changes in undesirable ways. It is often expensive or inconvenient to clean the coated surface, and the detergents, surfactants, fragrances, alkali, lime, and/or other chemicals used to clean the surface can make their way into the environment. Thus, it is desirable to have a coating that keeps dirt from sticking to the surface, is self-cleaning, and contains environmentally benign chemicals. The present disclosure identifies inorganic coating systems that provides a hydrophilic surface, self-cleaning and has few or no polluting organic solvents.

In some embodiments, a hydrophilic, self-cleaning coating composition may comprise at least one metal organic oxide and at least one inorganic photocatalytic pigment, wherein the metal organic oxide contacts the inorganic photocatalytic pigment non-covalently. The term “metal organic oxide” means both metal organic oxides and organic metal oxides. Examples of metal organic oxides that may be used in the composition include, but are not limited to, silanes such as tetra(2-propene) orthosilicate, tetra-ethylorthosilicate and tetra-isopropylorthosilicate, titanium isopropoxide, zirconium isopropoxide, or any combination thereof. Other non-limiting examples of metal organic oxides include propen-2-oxides of Be, V, Nb, Hf, Ta, W, Os, Ge, As, Te, Po, Ac, Th, Np, Pu, Am, Cm, Al, Zr, Re, Ti, Si or any combination thereof.

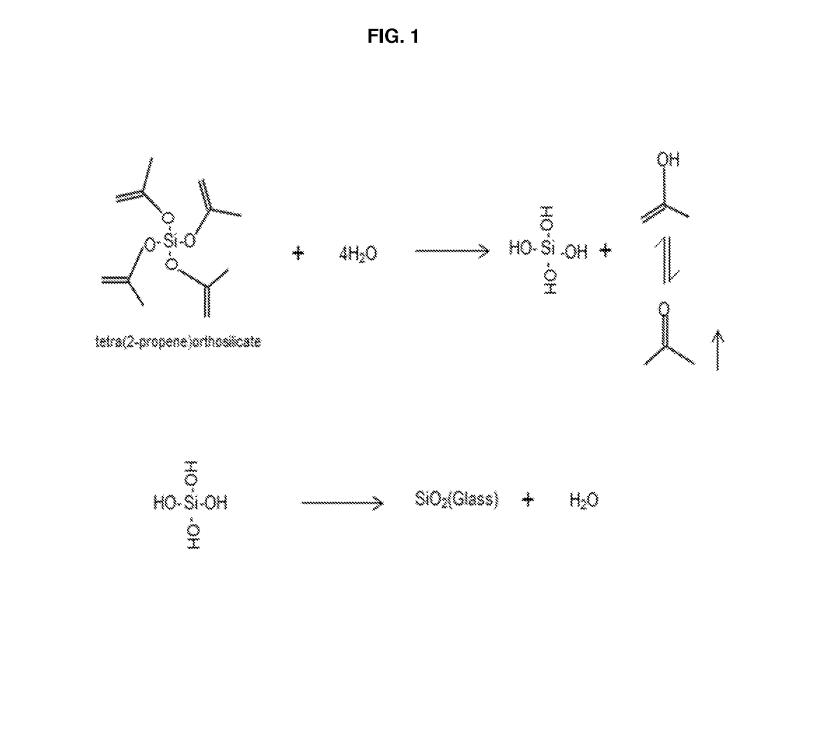

The silanes in the present disclosure may serve as both the vehicle and the binder of the coating, as illustrated in FIG. 1. For example, tetra(2-propene)orthosilicate liquid polymerizes in the presence of water and the reaction may be explained as follows. Tetra(2-propene)orthosilicate absorbs water from the atmosphere resulting in formation of tetrahydroxysilane and 2-propeneol. Further, 2-propeneol immediately tautomerizes to acetone and is released to the atmosphere. The tetrahydroxysilane polymerizes into silicon dioxide (glass) which constitutes the binder, and forms a tough, durable layer that protects the substrate. The silicate binder may impair water, electrolytes, and other contaminants from contacting the substrate, thus reducing corrosion and preserving substrate integrity.

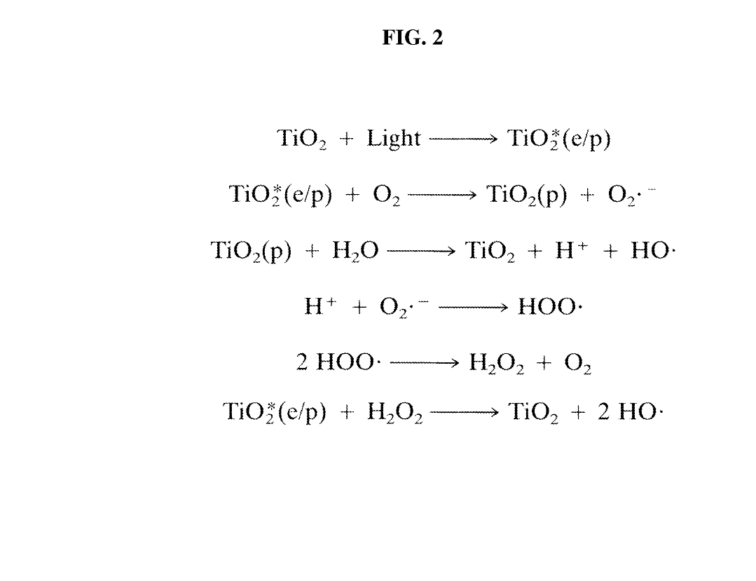

Paints and coatings of the present disclosure include a photocatalytic pigment material, such as titanium dioxide, in their composition. The photocatalytic properties of titanium dioxide result from the promotion of electrons from the valence band to the conduction band under the influence of ultraviolet (UV) and near-UV radiation. The reactive electron-hole pairs that are created migrate to the surface of the titanium dioxide particles where the holes oxidize adsorbed water to produce reactive hydroxyl radicals and the electrons reduce adsorbed oxygen to produce superoxide radicals. Both the hydroxyl radicals and superoxide radicals can degrade nitrogen compounds and volatile organic compounds in the air (FIG. 2). In view of these properties, photocatalytic titanium dioxide may be employed in coatings and the like to remove pollutants from the air. Such coatings may also have an advantage of being self-cleaning since soil (or grease, mildew, mold, algae, etc.) is also oxidized on the surface.

Titanium dioxide commonly occurs in two crystal phases, rutile and anatase, that differ in lattice structures, refractive indices, and densities. In some embodiments, the titanium dioxide may be a rutile titanium dioxide particle, an anatase titanium dioxide particle, or a mixture thereof. The titanium dioxide particles used in the coatings may have an average particle diameter of about 300 nanometers to about 1 micron, about 300 nanometers to about 750 nanometers, or about 300 nanometers to about 500 nanometers. Specific examples include about 300 nanometers, about 400 nanometers, about 500 nanometers, about 600 nanometers, about 750 nanometers, about 800 nanometers, about 1 micron and ranges between (and including the endpoints) any two of these values. In some embodiments, a composition comprising a plurality of photocatalytic pigment material particles, such as titanium dioxide, will have at least 50%, at least 60%, at least 70%, at least 80%, at least 90%, at least 95%, at least 96%, at least 97%, at least 98%, at least 99%, or at least 99.5% of the particles with the recited particle diameter or range of particle diameter. It is known that smaller particle sizes provide greater surface area and strong photo-catalytic effect. However, pigments smaller than the wavelength of light (400 nanometers) will not scatter light and will be transparent. Since the pigment particle size affects the photo-catalytic behavior, a blend of larger pigments (for scattering) and smaller pigments (for stronger photo-catalytic effect) can be used to create coatings tailored to the specific application. Apart from titanium dioxide particles, the coating compositions may contain other inorganic photocatalytic pigments. Examples include, but not limited to, zinc oxide, copper oxide, hematite, magnetite, wüstite, chromium oxide, tin dioxide, carbonate pigment, sodium tantalite, or any combination thereof, or any mentioned pigment, or any combination thereof, in further combination with titanium dioxide.

Paints and coatings of the present disclosure may contain one or more additives that alter the properties of the paint, from shelf life to application and longevity, to health and safety. Such additives may be added at any step during the manufacture of the paint. Additives include, but are not limited to, pigments, catalysts, thixotropic agents, preservatives and the like. In some embodiments, thixotropic agents and rheology modifiers may be added to achieve the desired viscosity and flow properties, respectively. In addition, thixotropic agents may also attenuate pigment sedimentation during storage. Examples of thixotropic agents include, but not limited to, modified castor waxes such as amine or amide waxes.

The paints according to the disclosure may further comprise one or more pigments. The term “pigments” is intended to embrace, without limitation, pigmentary compounds employed as colorants, including white pigments, as well as ingredients commonly known in the art as “opacifying agents” and “fillers.” Pigments may include any particulate organic or inorganic compound that provide the ability to obscure a background of contrasting color (hiding power). Use of titanium dioxide particles imparts white color to the paints. Various gray tones may be produced by the addition of iron oxide black. Shades of yellow, brown, red, pink, and orange may also be obtained by other forms of iron oxide. Blue and green colors may be obtained by including phthalocyanine pigments in the paints.

The coatings may also contain catalysts to promote the polymerization of silicates and curing of the paint. Examples of catalysts include, but not limited to, hydroxides, sulfuric acid, dibutyltin compounds, dilaurate compounds, organozinc compounds, organozirconium compounds or any combination thereof.

In some embodiments, preservatives and fungicides may be added to the coating compositions in low doses to protect against the growth of microorganisms. Preservatives such as methyl benzisothiazolinones, chloromethylisothiazolinones, barium metaborate and 1-(3-chloroallyl)-3,5,7-triaza-1-azoniaadamantane chloride may be used.

The coating compositions may also comprise extenders or fillers which may serve, for example, to thicken coating films and/or support the structure of the coating composition. Some extenders may also provide hiding power and function as pigments, particularly above critical pigment volume concentrations, and most extenders are color neutral. Common extenders include, for example, clays such as kaolin clays, china clays, tales, quartz, barytes (barium sulphate) and carbonate salts, such as calcium carbonate, zinc carbonate, magnesium carbonate or mixtures thereof.

In some embodiments, the coating compositions may contain silicone or acrylic polymers. The acrylic polymers may include latex, such as natural latex, neoprene latex, nitrile latex, acrylic latex, vinyl acrylic latex, styrene acrylic latex, styrene butadiene latex, or the like. Compositions may include a single polymer or a mixture of two or more polymers that may be of the same class or different. For example, organic polymers may be combined with a silicon-based polymers. The compositions may also contain silicone polymers such as polydimethyl-siloxanes.

The coatings of the present disclosure may be used as a decorative coating, as an industrial coating, as a protective coating, as a self-cleaning coating or any combination thereof. The coatings may be applied to any substrate, such as an article, an object, a vehicle or a structure. Although no particular limitation is imposed on the substrate to be used in the present disclosure, glasses, plastics, metals, ceramics, wood, stones, cement, fabric, paper, leather, and combinations or laminations thereof may be used. The coating may be applied to a substrate by spraying, dipping, rolling, brushing, or any combination thereof.

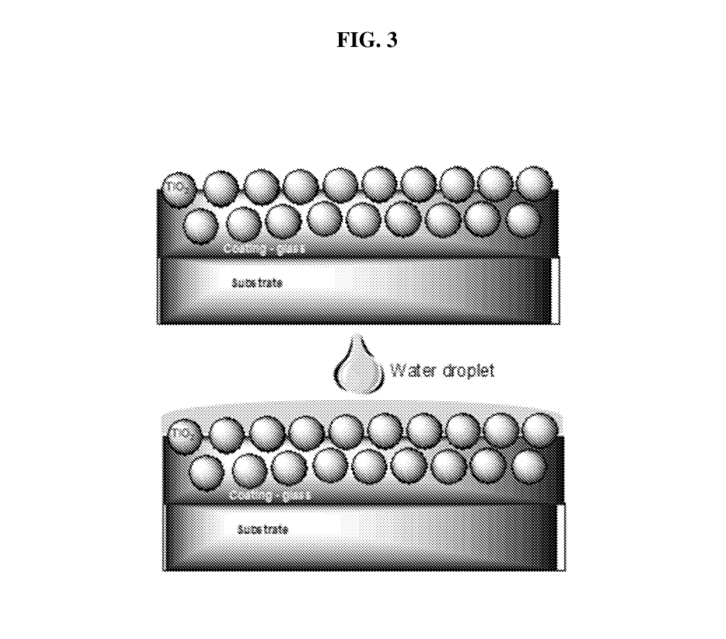

The paints and coating of the present disclosure may be prepared by mixing the inorganic photocatalytic pigments described herein in a solution of metal organic oxide. In some embodiments, mixing may involve mixing inorganic photocatalytic pigments and metal organic oxide in solid phase followed by addition of a liquid. In other embodiments, both the inorganic photocatalytic pigment and the metal organic oxide may be mixed in liquid phase. Further, the metal organic oxides and the inorganic photocatalytic pigments may not form covalent bonds in the present composition. In some embodiments, the coating composition may be a slurry or a suspension of inorganic photocatalytic pigment and the metal organic oxide. An exemplary coating composition is a slurry of tetra(2-propene)orthosilicate and titanium dioxide particles. The coating absorbs water from the atmosphere to cure and crosslink at room temperature. In some embodiments, no organic solvents are used to create the coating, which is, thus, environmentally benign. However, in some embodiments, some organic solvents may be generated during curing and cross-linking of silicates. FIG. 3 illustrates a representative coating embodiment. The paint when applied to a substrate cures into a tough glass-like coating. Titanium dioxide pigments are exposed at the surface and are also imbedded throughout the coating. A new layer of titanium dioxide pigments is exposed as the surface wears. Thus, the surface always remains hydrophilic in nature. The glass-like coating has excellent adhesion to the substrate and protects the substrate from contaminants. The coating is self-cleaning and hydrophilic in nature due to glass-like surface and hydrophilic titanium dioxide particles. Any organic compound that contaminate the surface are decomposed by the photocatalytic action of the titanium dioxide pigments.

### EXAMPLES

### Example 1

### Preparation of a Hydrophilic Coating—Sample 1

A hydrophilic coating is prepared having the following components: 297 grams of commercially available anatase titanium dioxide particles, 24.5 grams of Mica 325 mesh, 5 grams of thickener (clay), 162.5 grams of tetra(2-propene)orthosilicate, 2.5 grams of molecular sieve, 0.3 grams of dibutyltin dilaurate and 8 grams of anti-settling agent (polyethylene wax). The components are mixed under high shear for 30 minutes.

### Example 2

### Preparation of a Hydrophilic Coating—Sample 2

A hydrophilic coating is prepared having the following components: 297 grams of commercially available anatase titanium dioxide particles, 24.5 grams of Mica 325 mesh, 5 grams of thickener (clay), 162.5 grams of tetra-ethylorthosilicate, 2.5 grams of molecular sieve, 0.3 grams of dibutyltin dilaurate and 8 grams of anti-settling agent (polyethylene wax). The components are mixed under high shear for 30 minutes.

### Example 3

### Evaluation of Hydrophilic Property

The hydrophilic coating (Sample 2) is coated on a glass surface and allowed to dry at room temperature. The surface free energy and the water droplet contact angle of the hydrophilic coating is measured as follows. A Zisman plotting method is employed for measuring surface free energy. The surface tension of various concentration of the aqueous solution of magnesium chloride is plotted along the X-axis and the contact angle in terms of cos 0 is plotted along the Y-axis. A graph with a linear relationship between the two is obtained. The graph is extrapolated such that the surface tension at contact angle 0° is measured and is defined as the surface free energy of the solid. The surface free energy of the glass surface will be 83 milliNewtons/meter.

### Example 4

### Evaluation of Hydrophilic Coating

The hydrophilic coating (Sample 1) is coated on a glass substrate and evaluated for the following properties.

Hydrophilicity: The water droplet contact angle in air is measured by using DropMaster 500 (Kyowa Interface Science Co., Ltd) and will be 10°.

Water resistance: The hydrophilic coating is subjected to a rubbing treatment with sponge in 10 reciprocations in water while applying a load of 1 kg, and the amount of residual film is calculated from a change of weight before and after the rubbing treatment. The weight of the residual film will be 99% of the initial weight before rubbing.

Weather resistance: The hydrophilic coating is exposed in a chamber to a xenon arc lamp that is calibrated to mimic the sun spectral characteristics. The exposure is performed for 500 hours and is evaluated for hydrophilicity, water resistance and durability. The hydrophilic coating will exhibit substantially the same properties before and after the exposure.

### Example 5

### An Object Coated with Hydrophilic Paint

A wooden chair is painted with a hydrophilic coating (Sample 1) and is allowed to dry at room temperature. The surface free energy of the chair is measured as explained in Example 3 and will be 83 milliNewton/meter. The anti-fouling property of the coating is measured as follows: A line is drawn on the coated chair using oily ink A similar line is also drawn on a chair which is not coated. A water jet is continuously applied on both the surfaces and periodically checked whether the oily line is erased. The oily ink applied on the coated chair will be erased after 1 minute whereas the oily line on the un-coated chair will be present.

### Example 6

### Measuring Self-Cleaning Properties

The self-cleaning properties of each paint sample is investigated based on their ability to degrade the organic dye methylene blue. As the dye is degraded to water, carbon dioxide, and nitrogen containing species, a loss of color is observed. The photoactivity is monitored by measuring the brightness. The protocol is as follows: a film of paint is coated on a substrate such as a glass plate. The film thickness is similar to that used in the final application and generally not less than 25 microns thick when dry and the paint film is allowed to dry at least overnight. A solution of methylene blue in water (0.373 grams/L) is prepared and applied on the coated substrate and allowed to sit for about 60 minutes. The excess of methylene blue solution is removed and the substrate surface is dried and brightness value of the surface is measured. The substrate surface is exposed to UV light for about 48 hours at an intensity of 30 to 60 W/m² (300-400 nm wavelengths) and the brightness value is re-measured. The brightness value will be 20% less than the initial value, thus demonstrating the self-cleaning power of the coating.

### Example 7

### Measuring Photocatalytic Activity of the Coating

A 200 mM stearic acid in methanol is applied evenly on a glass surface coated with a hydrophilic coating (Sample 1). The stearic acid coating is allowed to dry and the glass surface is exposed to a UV lamp source (intensity of 40 W/m²) to induce photocatalytic activity. The glass surface is periodically examined for the presence of stearic acid using an infra-red spectrophotometer and the rate of degradation of stearic acid is calculated.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially or” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A coating composition comprising at least one metal organic oxide and at least one inorganic photocatalytic pigment, wherein the at least one metal organic oxide contacts the at least one inorganic photocatalytic pigment non-covalently.

2. The composition of claim 1, wherein the at least one metal organic oxide is tetra(2-propene) orthosilicate, tetra-ethylorthosilicate, tetra-isopropylorthosilicate, titanium isopropoxide, zirconium isopropoxide, or any combination thereof.

3. The composition of claim 1, wherein the at least one metal oxide is a propen-2-oxide of Be, V, Nb, Hf, Ta, W, Os, Ge, As, Te, Po, Ac, Th, Np, Pu, Am, Cm, Al, Zr, Re, Ti, Si or a combination thereof.

4. The composition of claim 1, wherein the at least one inorganic photocatalytic pigment is titanium dioxide, zinc oxide, copper oxide, hematite, magnetite, wüstite, chromium oxide, tin dioxide, a carbonate pigment, sodium tantalite, or any combination thereof.

5. The composition of claim 1, wherein the at least one inorganic photocatalytic pigment is a rutile titanium dioxide particle, an anatase titanium dioxide particle, or a combination thereof.

6. (canceled)

7. The composition of claim 1, wherein the at least one inorganic photocatalytic pigment is a titanium dioxide particles dispersed in a solution of tetra(2-propene)orthosilicate.

8. (canceled)

9. The composition of claim 1, further comprising a catalyst, wherein the catalyst is a hydroxide, sulfuric acid, a dibutyltin compound, a dilaurate compound, an organozinc compound, an organozirconium compound, or any combination thereof.

10. The composition of claim 1, further comprising a pigment, wherein the pigment comprises iron oxide or a phthalocyanine, or a combination thereof.

11. The composition of claim 1, further comprising a thixotropic agent, wherein the thixotropic agent is a modified castor wax.

12. The composition of claim 1, wherein the composition further comprises one or more silicone polymers or one or more organic polymers, or a combination thereof.

13. (canceled)

14. The composition of claim 1, wherein the coating is a hydrophilic, self-renewing coating.

15. A method of coating a substrate, the method comprising:
contacting the substrate with a coating composition comprising at least one metal organic oxide and at least one inorganic photocatalytic pigment, wherein the at least one metal organic oxide contacts the at least one inorganic photocatalytic pigment non-covalently.

16. The method of claim 15, wherein the at least one metal organic oxide is tetra(2-propene)orthosilicate, tetra-ethylorthosilicate, tetra-isopropylortho silicate, titanium isopropoxide, zirconium isopropoxide, or any combination thereof.

17. The method of claim 15, wherein the at least one metal oxide is a propen-2-oxide of Be, V, Nb, Hf, Ta, W, Os, Ge, As, Te, Po, Ac, Th, Np, Pu, Am, Cm, Al, Zr, Re, Ti, Si or a combination thereof.

18. The method of claim 15, wherein the at least one inorganic photocatalytic pigment is titanium dioxide, zinc oxide, copper oxide, hematite, magnetite, wüstite, chromium oxide, tin dioxide, a carbonate pigment, sodium tantalite, or any combination thereof.

19. The method of claim 15, wherein the at least one inorganic photocatalytic pigment is a rutile titanium dioxide particle, an anatase titanium dioxide particle, or a combination thereof.

20. (canceled)

21. The method of claim 15, wherein the at least one inorganic photocatalytic pigment is a titanium dioxide particles dispersed in a solution of tetra(2-propene)orthosilicate.

22. The method of claim 15, wherein the coating composition is contacted with the substrate by coating, spraying, dipping, rolling, brushing, or any combination thereof.

23. The method of claim 15, wherein the coating provides a hydrophilic, self-renewing coating to the substrate.

24. A coated substrate comprising:
a substrate;
a hydrophilic and self-cleaning coating on at least one surface of the substrate, wherein composition of the coating comprises at least one metal organic oxide and at least one inorganic photocatalytic pigment, wherein the at least one metal organic oxide contacts the at least one inorganic photocatalytic pigment non-covalently.

25. The coated substrate of claim 24, wherein the at least one metal organic oxide is tetra(2-propene)orthosilicate, tetra-ethylorthosilicate, tetra-isopropylorthosilicate, titanium isopropoxide, zirconium isopropoxide, or any combination thereof.

26. The coated substrate of claim 24, wherein the at least one metal oxide is a propen-2-oxide of Be, V, Nb, Hf, Ta, W, Os, Ge, As, Te, Po, Ac, Th, Np, Pu, Am, Cm, Al, Zr, Re, Ti, Si or a combination thereof.

27. The coated substrate of claim 24, wherein the at least one inorganic photocatalytic pigment is titanium dioxide, zinc oxide, copper oxide, hematite, magnetite, wüstite, chromium oxide, tin dioxide, a carbonate pigments, sodium tantalite, or any combination thereof.

28. The coated substrate of claim 24, wherein the at least one inorganic photocatalytic pigment is a rutile titanium dioxide particle or an anatase titanium dioxide particle, or a combination thereof.

29. (canceled)

30. The coated substrate of claim 24, wherein the at least one inorganic photocatalytic pigment is a titanium dioxide particle dispersed in a solution of tetra(2-propene)orthosilicate.

31. The coated substrate of claim 24, wherein the coating composition further comprises a pigment, a thixatropic agent, a catalyst, or any combination thereof.

32. (canceled)
